(19) United States
(12) Patent Application Publication
(10) Pub. No.: US 2022/0394932 A1
(43) Pub. Date: Dec. 15, 2022

(54) LOW STRESS PLANT LIMB TRAINER APPARATUS

(71) Applicants: KURT MACEY, PORTLAND, OR (US); RYAN AGUILAR, PORTLAND, OR (US)

(72) Inventors: KURT MACEY, PORTLAND, OR (US); RYAN AGUILAR, PORTLAND, OR (US)

(21) Appl. No.: 17/586,756

(22) Filed: Jan. 27, 2022

Related U.S. Application Data
(60) Provisional application No. 63/142,491, filed on Jan. 27, 2021.

(51) Int. Cl. A01G 7/06; A01G 17/00

(52) U.S. Cl. CPC A01G 7/06; A01G 17/005

(57) ABSTRACT

A plant limb training apparatus includes a first portion with a first fulcrum portion, a first portion arm extending from the first fulcrum portion and having a first limb engagement finger, the first fulcrum portion further including an interior race and ratchet teeth around the interior race; and, a second portion, the second portion including a second fulcrum portion, a second portion arm extending from the second fulcrum portion and having a second limb engagement finger, the second fulcrum portion configured to engage the first fulcrum portion within the first fulcrum portion interior race, the second fulcrum portion further including at least one pawl element disposed to selectively engage the plurality of ratchet teeth.

### CROSS-REFERENCE TO RELATED APPLICATIONS

This application is a nonprovisional of, and claims priority to, copending U.S. Provisional Application Ser. No. 63/142,491, filed Jan. 27, 2021, the entirety of which is hereby incorporated by reference.

### FIELD OF THE INVENTION

The present invention relates to apparatus for training limbs of fruit-bearing, ornamental and agricultural plants, shrubs and trees.

### BACKGROUND OF THE INVENTION

A grower may have many reasons to train plant limbs (small plants, shrubs and trees are referred to generally herein as “plants”) to grow in a particular shape or pattern. A grower may seek to achieve a particular aesthetic look for the plant. A grower may want to train stalks and branches (generally referred to herein as “limbs”) to utilize the available growing volume more efficiently, or to prevent one portion of a plant from shading, inhibiting other portions of that plant, or from shading or inhibiting other nearby plants. Preventing shading, or training a plant to achieve a flatter canopy to minimize apical dominance, may increase yield on some fruiting plants and flowers, and/or produce higher quality fruits or flowers. Alternatively, training limbs in a certain manner may provide for more efficient harvesting or maintenance of the plants or crops.

Commonly, growers resort to using string and/or zip ties to lash plant limbs to set-off anchor points and other complicated jury-rigged stakes and wires. This often results in damage to the limb epidermis where they are tied/lashed (which may cause scarring and/or make the plant more vulnerable to pests and disease), or breakage caused by excessive bending. As a plant being trained grows, the training apparatus must be adjusted, which entails a great deal of reworking and rejiggering for tie-lash systems. Frequently this leads growers to attempt to over-correct the bend angles and break or damage the plant limbs.

There is a need for an apparatus for training plant limbs which is simple, provides ability to apply controllable and adjustable bending stress directly at the desired location on the plant limb, and minimizes potential for damage to the limb epidermis.

### SUMMARY AND ADVANTAGES

An apparatus for training plant limbs includes a first portion, the first portion including a first fulcrum portion, a first portion arm extending from a first portion arm first end connected to the first fulcrum portion to a first portion arm second end, a first limb engagement finger projecting from the first portion arm proximate the first portion arm second end, the first fulcrum portion further including an interior race and a plurality longitudinally oriented ratchet teeth disposed circumferentially around the interior race; and, a second portion, the second portion including a second fulcrum portion, a second portion arm extending from a second portion arm first end connected to the second fulcrum portion to a second portion arm second end, a second limb engagement finger projecting from the second portion arm proximate the second portion arm second end, the second fulcrum portion configured to engage the first fulcrum portion within the first fulcrum portion interior race, the second fulcrum portion further including at least one pawl element disposed to selectively engage the plurality of ratchet teeth. When the first portion first fulcrum portion rotationally engages the second portion second fulcrum portion the first and second limb engagement fingers are in opposed orientation. The first fulcrum portion and second fulcrum portion defining a central rotation axis about which the first portion arm and second portion arm rotate in opposed directions.

When the apparatus including a neutral position wherein the first portion arm and second portion arm impart no bending stress on a straight limb engaged by the apparatus, the neutral position further defining a first limb engagement finger upstream offset and radial offset and a second limb engagement finger downstream offset and radial offset, wherein the first limb engagement finger radial offset and second limb engagement finger radial offset are equal magnitude and direction. The apparatus may include unidirectional, square or other types of ratchet teeth, selected by the user/manufacturer based on the application and material of construction. The apparatus may include a single pawl in its simplest configuration, or a plurality of pawls to provide greater locking strength.

The apparatus second arm is longer than the first arm to provide clearance for the arms to rotate 360 degrees in order to reset the apparatus.

The apparatus may include a third limb engagement finger projecting from the second portion arm between the second portion arm first and second ends and distal from the second limb engagement finger.

The respective limb engagement fingers may include a retaining lip. The limb engagement finger interior surfaces may be flat or may incorporate a curved/conformal surface to distribute pressure along an engaged limb and minimize risk of damage to the limb epidermis. Alternatively, the limb engagement fingers may be simple posts where the risk of damage to the epidermis is low or not a concern.

The apparatus and methods of use described provide for low-stress training of plant limbs, which avoids breaking the limbs which is less complicated, faster, and more controllable than existing apparatus and methods. The apparatus and methods are useful for decorative purposes, or to train fruit and vegetable plants for higher yields and more efficient harvesting. The apparatus can be scaled for larger species such as fruit trees and decorative trees. The apparatus and methods are useful for both indoor and outdoor plants, optimizing space and maximizing flower and/or fruit output. For outdoor cultivators, it can help to keep a crop low profile or more uniform for more efficient maintenance, fertilizing, application of pest control methods and/or harvesting.

Low-stress limb training enables growers to fully exploit the available space and light by manipulating the growth pattern of plants. Many plants tend to grow into a formation known as apical dominance, where the plant is bushier at the bottom and narrows to a single elongated cola at the apex. This natural formation tends to result in a single dominant flower or fruit at the top of the plant, which monopolizes nutrients and hormones, leaving smaller yields on the lateral branches. The apparatus and methods allow the user to encourage such plants to flatten at the canopy, thus providing more even access to light, and multiple thriving flower/fruit sites. This constriction allows sugars and growth hormones to distribute more evenly. By flattening out the canopy, the entire plant also receives more light, promoting the growth of more flowers and fruits and larger yields.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows an exploded view of a first embodiment.

FIG. 2 shows a side view of a first embodiment.

FIG. 2A shows a partial cross-section view of a first embodiment.

FIG. 3A shows a first embodiment engaged against a branch, in “neutral” position.

FIG. 3B shows a first embodiment engaged against a branch, with a small magnitude of branch displacement and bend angle less than 90-degrees.

FIG. 3C shows a first embodiment engaged against a branch, with a larger magnitude of branch displacement and bend angle of 90-degrees.

FIG. 3D shows a first embodiment engaged against a branch, with a greater magnitude of branch displacement and bend angle of greater than 90-degrees.

FIG. 3E shows a first embodiment engaged against a branch, with a greater magnitude of branch displacement and bend angle of approximately 180-degrees.

FIG. 4 shows a first embodiment and method of resetting the device.

FIG. 5 shows a first embodiment installed to hold a partially broken branch in order to allow it to heal in the desired angle, without completely separating.

FIG. 6 shows a first embodiment engaged to a branch and an external anchor.

FIG. 7 shows a first side view of set of first embodiments of different sizes.

FIG. 8 shows a second side view of a set of first embodiments of different sizes.

FIG. 9 shows a first side view of a second embodiment.

FIG. 10 shows a second side view of a second embodiment.

FIG. 11 shows a terminal side view of a first portion of a second embodiment.

FIG. 12 shows an outside side view of a first portion of a second embodiment.

FIG. 13 shows a terminal side view of a second portion of a second embodiment.

FIG. 14 shows an outside side view of a second portion of a second embodiment.

FIG. 15 shows perspective view of a second portion of a second embodiment.

FIG. 16 shows perspective view of a second portion of a second embodiment.

FIG. 17 shows perspective view of a second portion of a second embodiment.

FIG. 18 shows partial cross-section of a third embodiment.

FIG. 19 shows partial cross-section of a fourth embodiment.

FIG. 20 shows view of the limb engagement fingers of a fifth embodiment.

### REFERENCE NUMBERS USED IN DRAWINGS

Turning now descriptively to the drawings, in which similar reference characters denote similar elements throughout the several views, the figures illustrate the of the present invention. With regard to the reference numerals used, the following numbering is used throughout the various drawing figures:

| Reference Nr. | Description |
|---|---|
| 100 | First Embodiment |
| 102 | First portion |
| 104 | First fulcrum portion |
| 106 | First limb engagement finger |
| 108 | First fulcrum portion interior race |
| 110 | First portion arm |
| 112 | First limb engagement finger terminal end |
| 114 | First limb engagement finger retaining lip |
| 116 | First limb engagement finger inner surface |
| 118 | First fulcrum portion retaining groove |
| 120 | Ratchet teeth |
| 122 | First limb engagement finger upstream off |
| 124 | First and second limb engagement finger radial offset |
| 126 | First fulcrum portion outer end |
| 128 | First fulcrum portion terminal end |
| 130 | Second portion |
| 132 | Second fulcrum portion |
| 132a | Second fulcrum portion first half |
| 132b | Second fulcrum portion second half |
| 134 | Second limb engagement. finger |
| 136 | Second fulcrum portion first longitudinal slot |
| 138 | Second fulcrum portion second longitudinal slot |
| 140 | Second portion arm |
| 142 | Second limb engagement finger terminal end |
| 146 | Second limb engagement finger inner surface |
| 148a | Second fulcrum portion first projecting ridge |
| 148b | Second fulcrum portion second projecting ridge |
| 150 | Second limb engagement linger downstream offest |
| 152 | Pawl |
| 152a | Pawl |
| 152b | Pawl |
| 154 | Second fulcrum portion outer end |
| 156 | Second fulcrum portion terminal end |
| 158 | Third limb engagement finger |
| 160 | First portion arm first end |
| 162 | First portion arm second end |
| 164 | First limb engagement linger transverse width |
| 166 | Second portion arm first end |
| 168 | Second portion arm second end |
| 170 | Second limb engagement finger transverse width |
| 172 | Rotational axis |
| 174 | Central aperture |
| 176 | [not used] |
| 178 | First fulcrum portion base flange |
| 200 | Second Embodiment |
| 202 | First portion |
| 204 | Hist fulcrum portion |
| 206 | First limb engagement finger |
| 208 | First fulcrum portion interior race |
| 210 | First portion arm |
| 212 | First limb engagement fra ger terminal end |
| 214 | [not used] |
| 216 | First limb engagement linger inner surface |
| 218 | First fulcrum portion retaining groove |
| 220 | Ratchet teeth |
| 277 | First limb engagement finger upstream offset |
| 224 | First and second limb engagement finger radial offset |
| 226 | First fulcrum portion outer end |
| 228 | First fulcrum portion terminal end |
| 230 | Second portion |
| 232 | Second fulcrum portion |
| 232a | Second fulcrum portion first half |
| 232b | Second fulcrum portion second half |
| 234 | Second limb engagement finger |
| 236 | Second fulcrum portion first longitudinal slot |
| 238 | Second fulcrum portion second longitudinal slot |
| 240 | Second portion arm |
| 246 | Second limb engagement finger terminal end |
| 248a | Second fulcrum portion first projecting ridge |
| 248b | Second fulcrum portion second projecting ridge |
| 250 | Second limb engagement finger downstream offset |
| 252 | Pawl |
| 254 | Second fulcrum portion outer end |
| 256 | Second fulcrum portion terminal end |
| 258 | [not used] |
| 260 | First portion arm first end |
| 262 | First portion arm second end |
| 264 | First limb engagement finger transverse width |
| 266 | Second portion arm first end |
| 268 | Second portion arm second end |
| 270 | Second limb engagement finger transverse width |
| 272 | Rotational axis |
| 274 | Central aperture |
| 276 | Pawl access aperture |
| 278 | First fulcrum portion base flange |
| 300 | Third Embodiment |
| 304 | First fulcrum portion |
| 320 | Ratchet teeth |
| 352a | First pawl |
| 352b | Second pawl |
| 400 | Fon rth Embodim ent |
| 404 | First fulcrum portion |
| 420 | Ratchet teeth |
| 432a | Second fulcrum portic |
| 432b | Second fulcrum portic |
| 452a | Pawl |
| 452b | Pawl |
| 452c | Pawl |
| 452d | Pawl |
| 474 | Central aperture |
| 500 | Fifth embodiment |
| 506 | First limb engagement |
| 510 | First portion arm |
| 534 | Second limb engagement |
| 540 | Second portion arm |

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

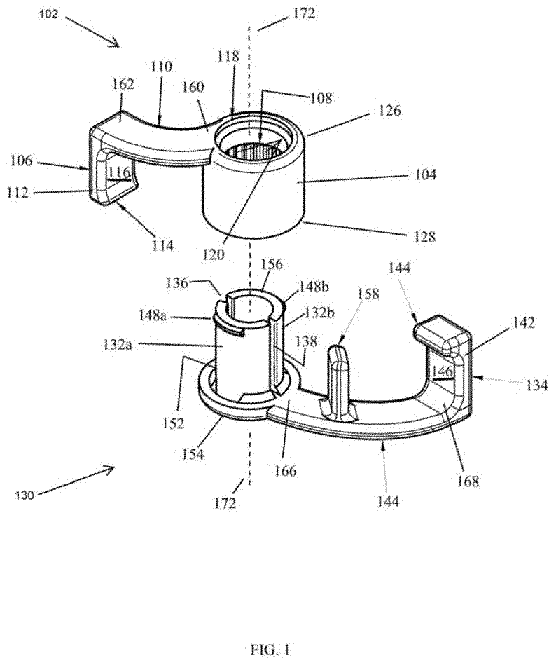

As shown in FIGS. 1-6 a first embodiment of a low stress training device 100 is provided. Low stress training device 10) includes a first portion 102 and a second portion 130 rotationally couplable to each other to rotate around a common rotational axis 172.

First portion 102 extends lengthwise from a first fulcrum portion 104 to a first limb engagement finger 106. In the embodiment, first fulcrum portion 104 is substantially cylindrical, extending from outer end 126 to terminal end 128. First fulcrum portion 104 includes circular interior race 108 extending between outer end 126 and terminal end 128. First fulcrum portion 104 includes a base flange 178 extending outward around first fulcrum portion outer end 126. Base flange 178 acts as a retainer and bearing surface against second fulcrum portion terminal end 156. First portion arm 110 extends lengthwise from a first end 160 rigidly connected to first fulcrum portion 104 proximate outer end 126 to a second end 162. First limb engagement finger 106 extends from first portion arm 110 proximate first portion arm second end 162 to a first limb engagement finger terminal end 112. First limb engagement finger 106 includes retaining lip 114 projecting from first limb engagement finger 106 proximate its terminal end 112 toward first fulcrum portion 104. In the embodiment, first limb engagement finger 106 defines a flat wall having a transverse width 164. First limb engagement finger inner surface 116 goes against a selected limb L.

First fulcrum portion retaining groove 118 extends circumferentially around interior race 108 proximate the outer end 126 of first fulcrum portion 104. Ratchet teeth 120 are disposed around interior race 108, extending proximate to first fulcrum portion terminal end 128. In the embodiment, ratchet teeth 120 are angled to permit first and second portions 102, 130 to rotate relative to each other in only one direction.

Third limb engagement finger 158 provides contact point for straightening limb L when bent in the opposite direction (counterclockwise as shown in the drawings) and to prevent reverse bowing, if needed. Not all applications of the apparatus would require a third limb engagement finger 158.

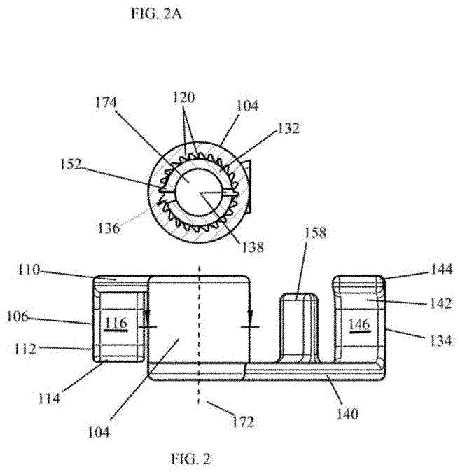

Second portion 130 includes second fulcrum portion 132 which defines a round cylindrical bushing to rotationally engage first fulcrum portion 102 interior race 108. Second fulcrum portion 132 extends from an outer end 154 to a terminal end 156. Second fulcrum portion 132 includes first and second opposed parallel longitudinal slots 136, 138, extending from proximate outer end 154 to terminal end 156, effectively creating a split-cylinder with opposed first and second halves 132a and 132b, respectively. Longitudinal slots 136, 138, permit second fulcrum portion 132 to compress for easier insertion/assembly. Pawl 152 is disposed proximate first longitudinal slot 136 proximate second fulcrum portion outer end 154 to engage ratchet teeth 120. In the embodiment, pawl 152 does not extend the full length of second fulcrum portion 132, but could if additional engagement strength were desired. Referring to FIG. 2A, in the embodiment a single pawl 152 is provided, but a plurality of pawls 152a, 152b & etc. could be provided, disposed around second fulcrum portion 132, to distribute stresses more evenly and provide stronger engagement, for example when used for trees or thick-limbed woody shrubs.

Second fulcrum portion 132 includes first and second projecting ridges 148a, 148b, to engage within first fulcrum portion retaining groove 118, preventing separation of first portion 102 from second portion 130 while permitting rotation about the rotation axis 172.

Second portion arm 140 extends lengthwise from a first end 166 rigidly connected to second fulcrum portion 132 proximate outer end 126 to a second portion arm second end 168. Second limb engagement finger 134 is rigidly connected to and extends orthogonally from second portion arm 140 proximate its second end 168 to second limb engagement finger terminal end 142. Second limb engagement finger retaining lip 144 projects from second limb engagement finger 134 proximate terminal end 142 toward second fulcrum portion 132. In the embodiment, second limb engagement finger 134 defines a flat wall having transverse width 170. Second limb engagement finger inner surface 146 goes against a limb L.

In the embodiment, third limb engagement finger 158 projects from second portion arm 140 at a location between second fulcrum portion 132 and second limb engagement finger 134, distal from second limb engagement finger 134 with sufficient separation to engage the anticipated limb sizes.

First, second and third limb engagement fingers 106, 134, 158 may have a non-flat shape, but providing flat surfaces to engage against a limb L distributes pressure to reduce risk of damaging the limb epidermis.

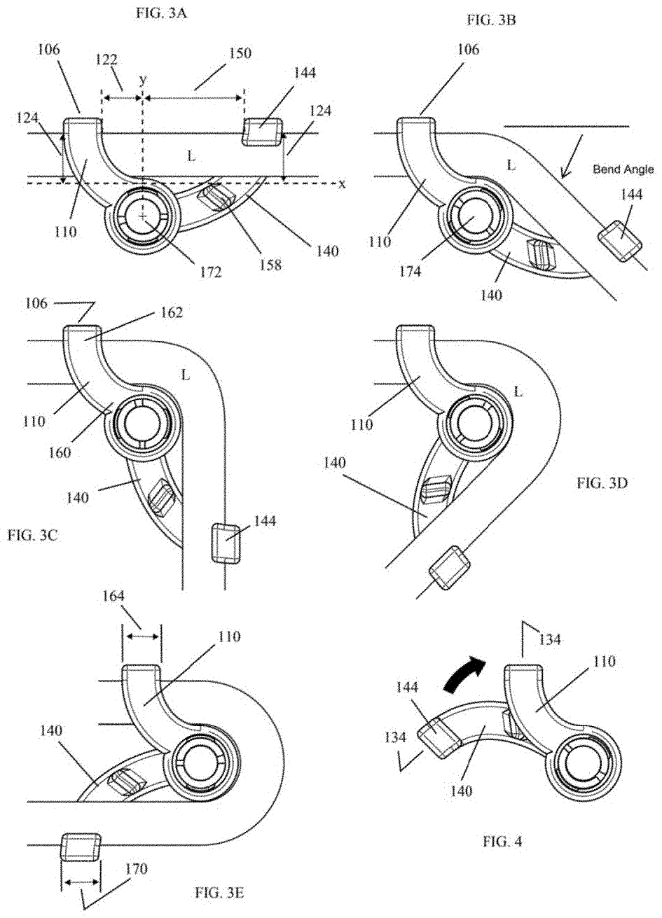

Referring to FIG. 3A, limb training device 100 is in the neutral position whereby no significant bending stress is imparted on a straight limb L. In this neutral position, cartesian x- and y-axes are shown for ease of description, with the x-axis parallel to limb L. With training device 100 in the “neutral” position, first limb engagement finger inner surface 116 and second limb engagement finger inner surface 146 are parallel to each other and to limb L and the x-axis. In this neutral position, first limb engagement finger 116 is offset along the x-axis from rotational axis 172. This x-axis offset, which we will refer to the “upstream lateral offset” 122, provides a lever arm to retain limb L in-place and relatively straight and flat on the “upstream” side when bending stress is applied. Still referring to FIG. 3A, in the neutral position second limb engagement finger inner surface 146 is offset along the x-axis from rotational axis 172 in the opposite direction, which we refer to as the “downstream lateral offset” 150. The distance along the y-axis between first fulcrum portion 104 and first limb engagement finger inner surface 116 is the same as that for second finger inner surface 146, and will be referred to as the “radial offset” 124. In the embodiment, first and second portion arms 110 and 140 are curved, but could also be straight—mounted at an angle skewed from radial, or other shapes, which are configured to provide adequate x- and y-axes offsets.

When first and second portions 102, 130, are coupled, first portion arm 110 and second portion arm 140 extend from opposed ends of the central fulcrum formed by first fulcrum portion 104 and second fulcrum portion 132, and face toward each other such that first and second limb engagement fingers 106, 134, respectively, rotate in approximately the same cylinder/disk plane. Second portion arm 140 is longer than first portion arm 110 so that the arms 110, 140, can rotate through 360-degrees in order to reset. First and second portion arms 110, 140, respectively, are curved toward each other in opposed arcs which allows the first and second portion arms 110, 140, respectively, to engage a straight branch.

Referring to FIGS. 3A-4, in operation, the user clips low stress trainer 100 onto the plant to be trained proximate the location of the intended bend. Rotate one of the arms to the preferred angle. The device 100 biases against rotating in one direction to prevent the object you are bending from returning to its natural state. Over time, as the branch conforms to the initial set angle, the user can incrementally increase the bend angle by simply ratcheting the arms further.

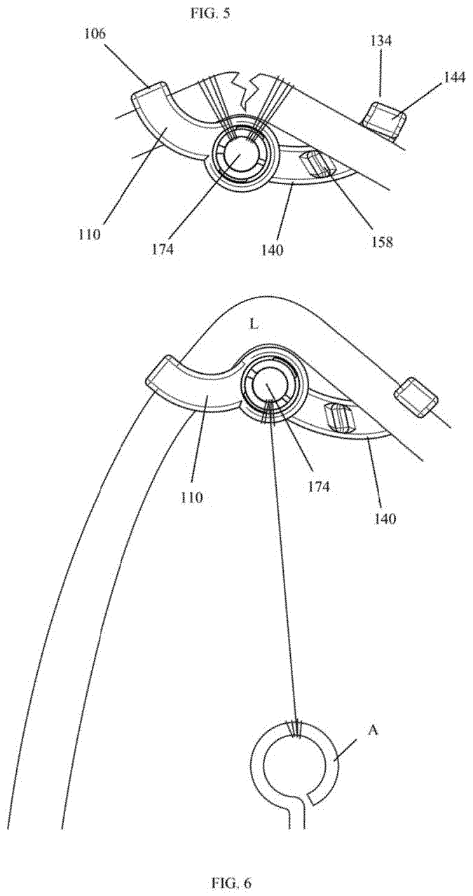

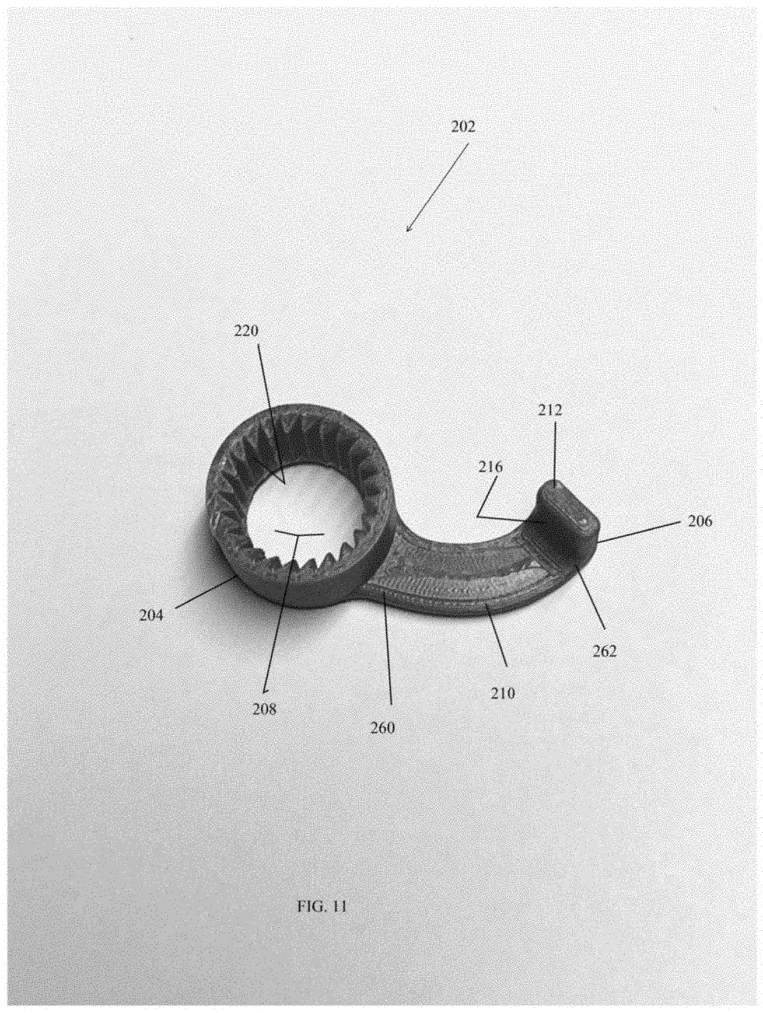

Referring to FIGS. 5 and 6, both first fulcrum portion 104 and second fulcrum portion 132 are open through their respective centers, defining a central aperture 174. Central aperture 174 may be used as connection point to couple device 100 to an exterior anchor point A or to pull it in a skewed direction. This provides the user additional control over the overall shaping they can achieve. Additionally, as shown in FIG. 11, central aperture 174 permits a partially broken limb L to be supported and held together in order to promote healing while maintaining a desired bend angle.

Once all of the stresses are relieved over time and the branch has permanently adapted to the bend, device 100 can be removed, reset and reused.

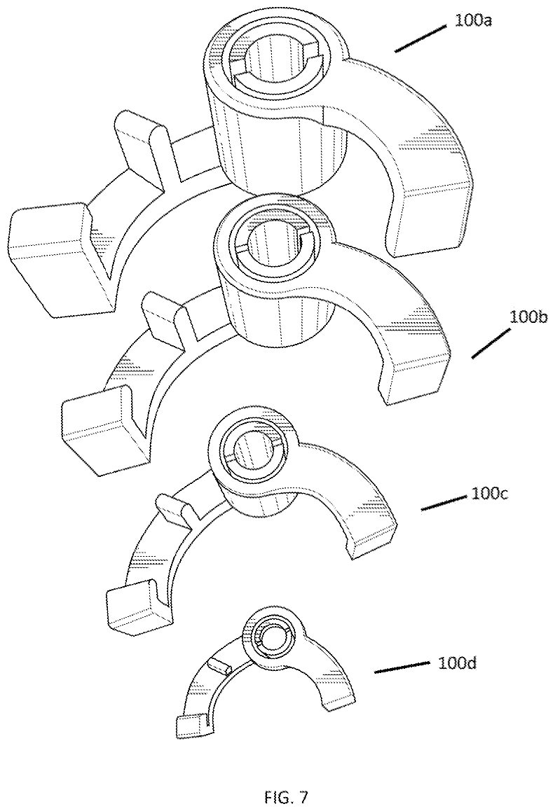

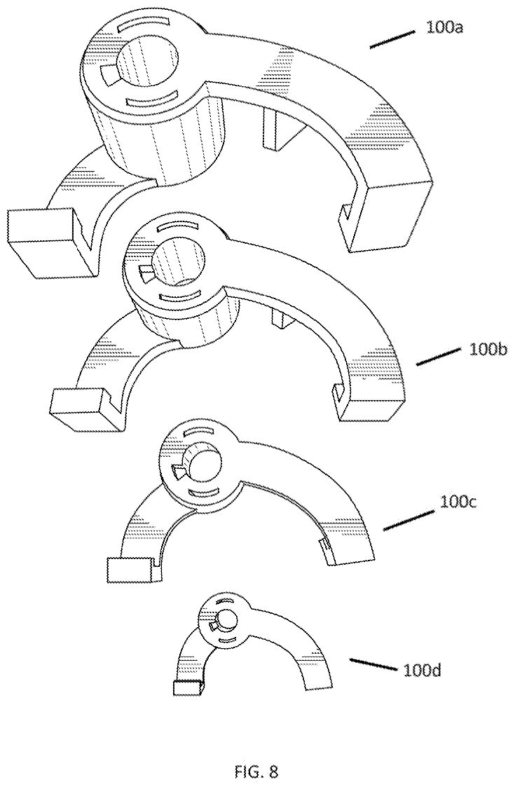

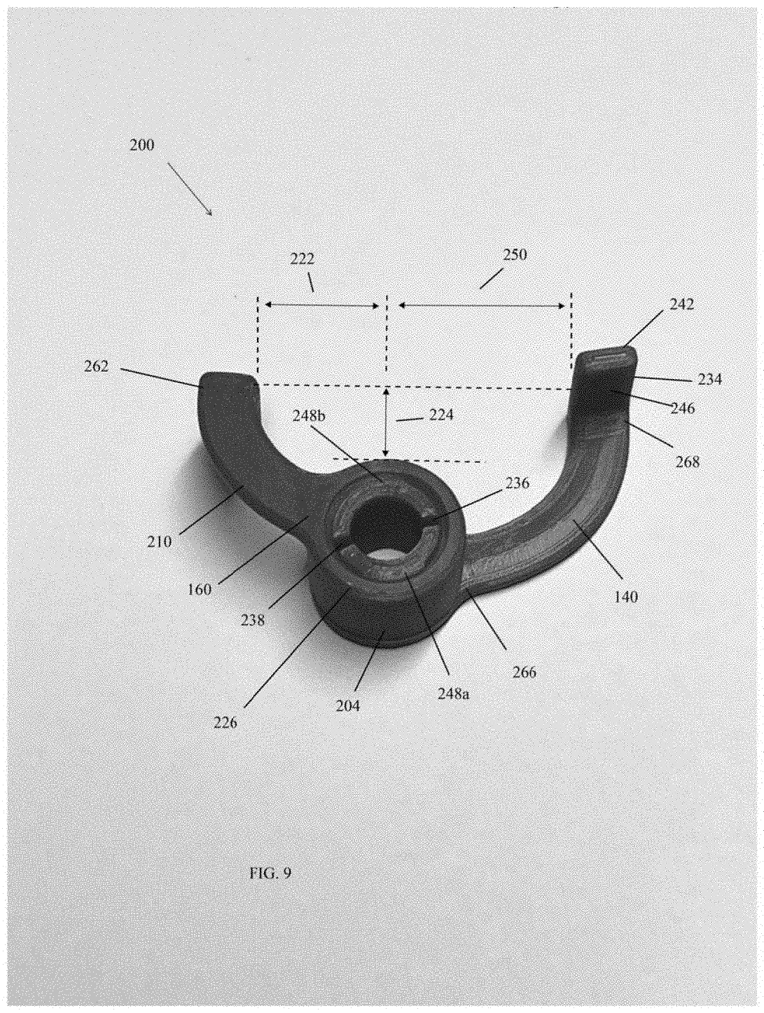

Referring to FIGS. 7 and 8, four scaled sizes 100a, 100b, 100c and 100d of a training device 100 as described above are shown, having different sizes, demonstrating that the training device is easily scaled up or down to adapt to larger or smaller limbs. The apparatus may be made from lightweight plastic so the device will not weigh down the target branch and cause it to droop over. In the embodiments. The apparatus may be made from a brightly colored plastic in order to be easily spotted in dense foliage for periodic adjustment and re-use.

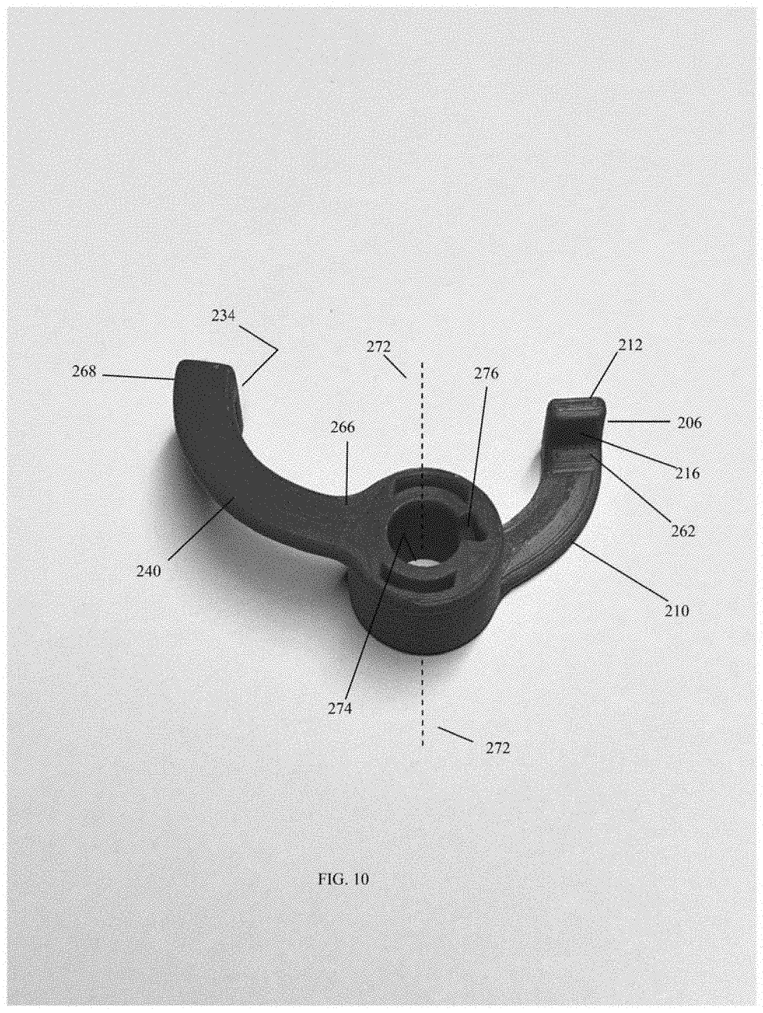

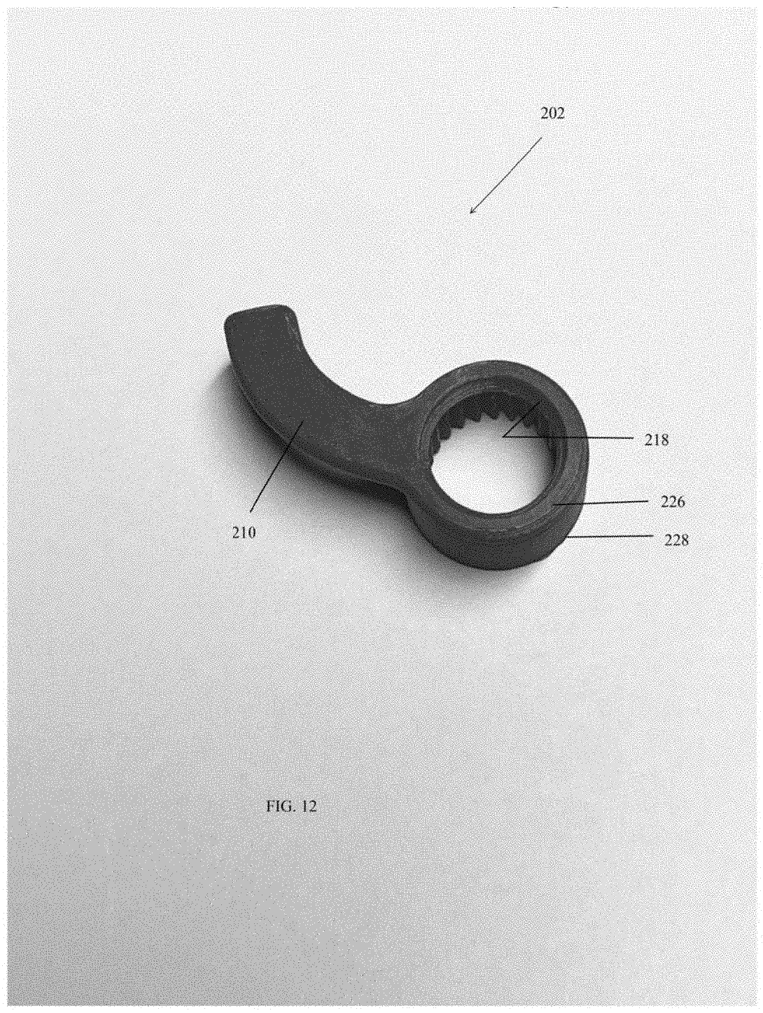

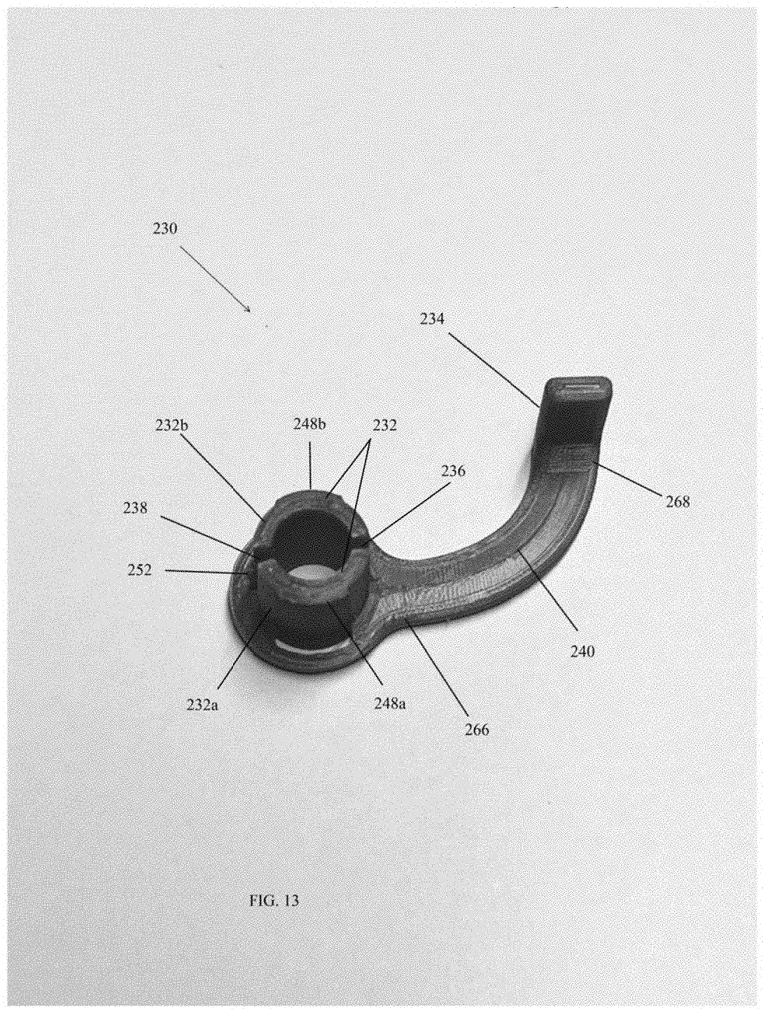

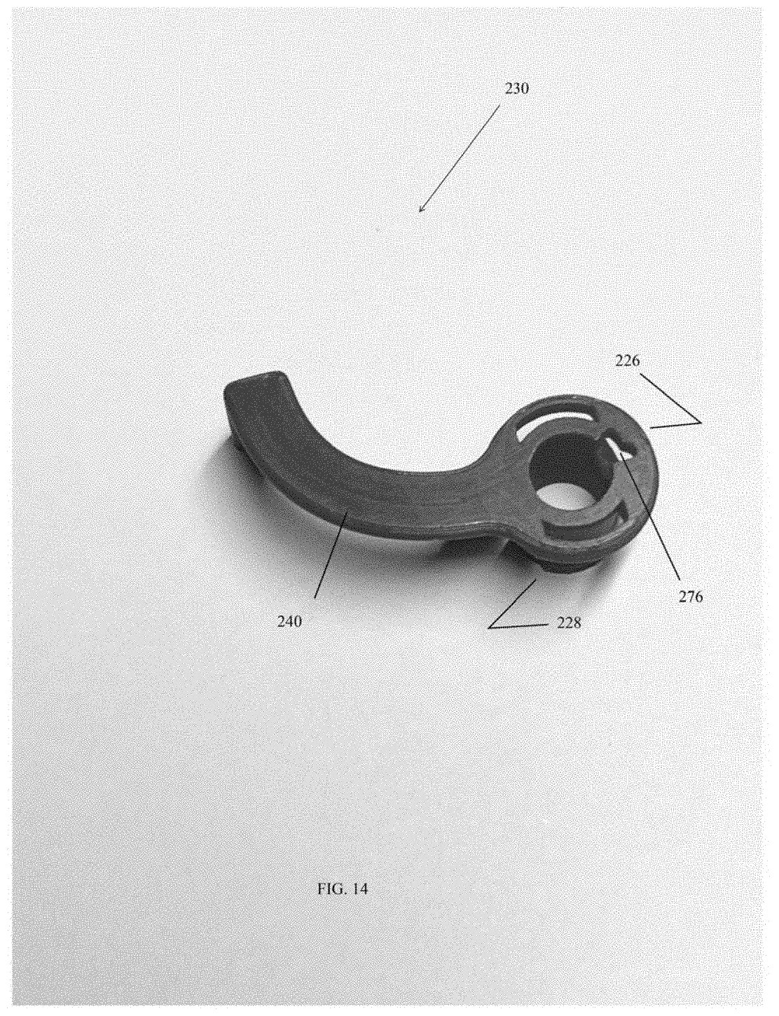

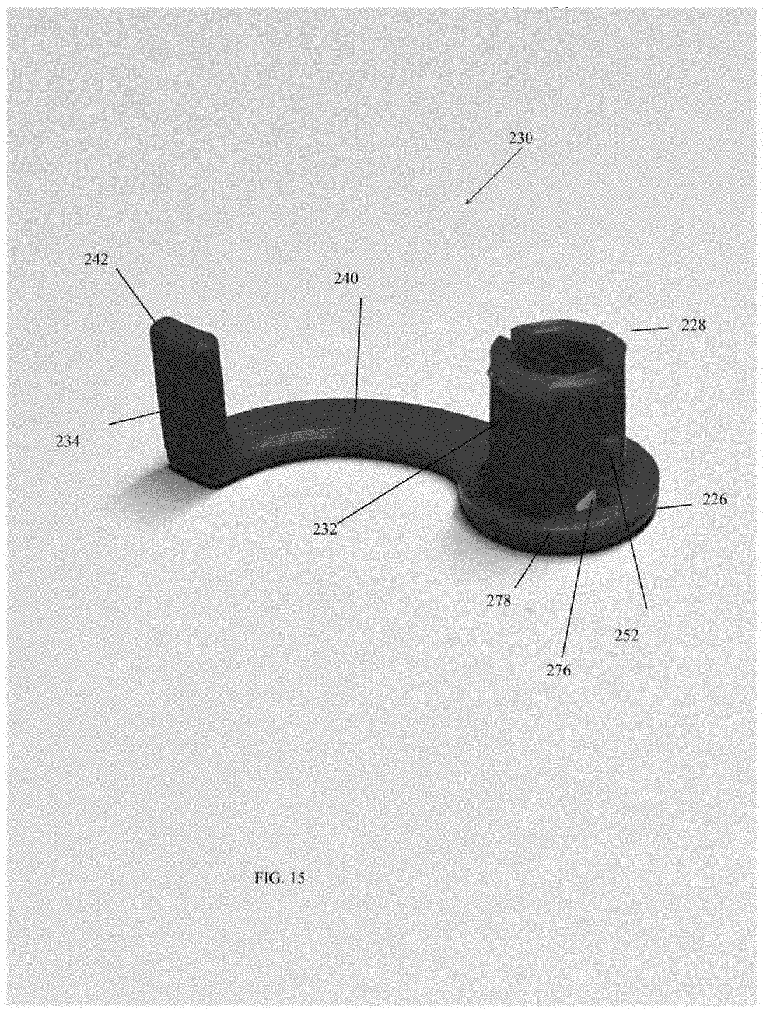

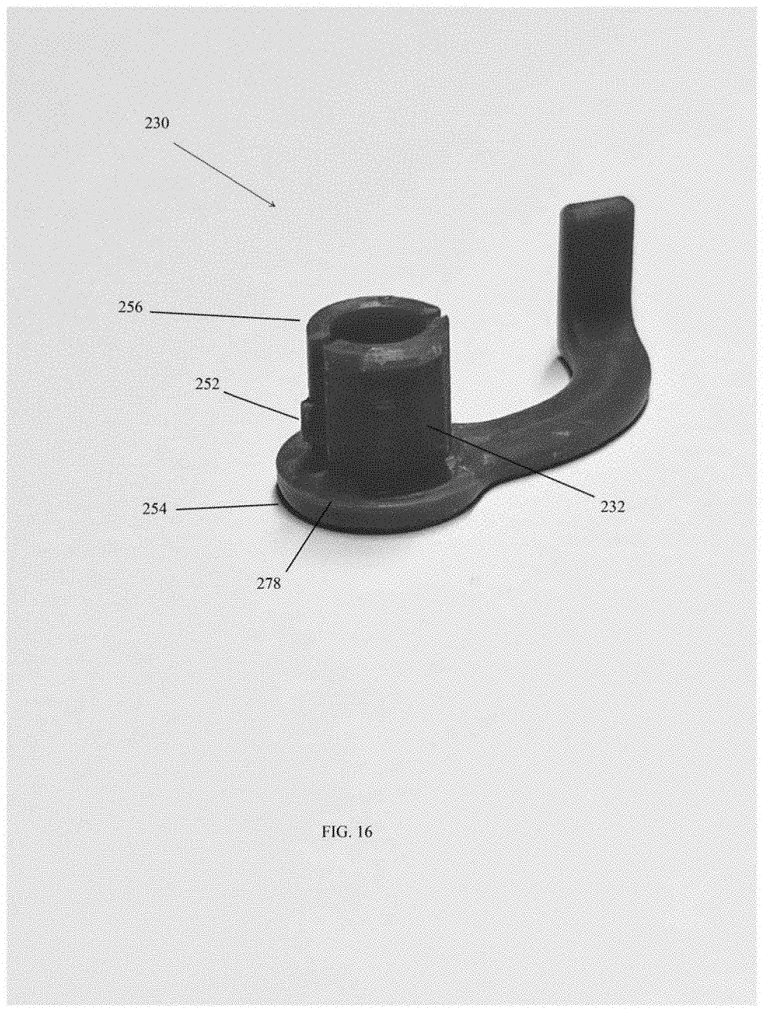

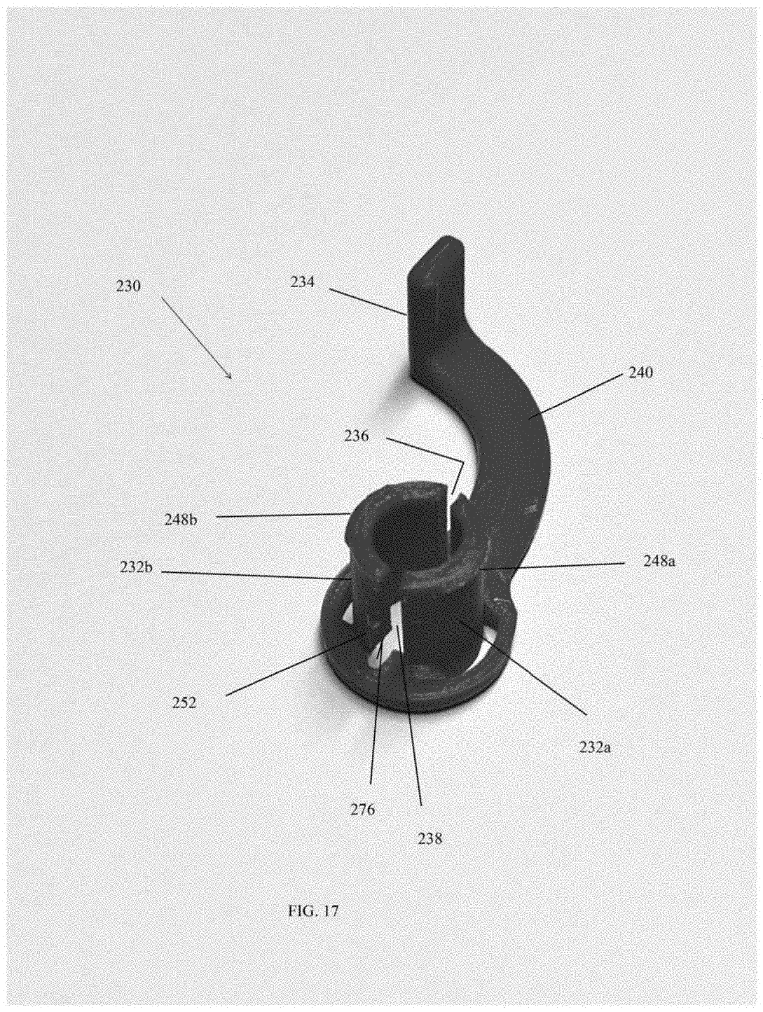

Referring to FIGS. 9-17, a second embodiment 200 of a limb training device is shown. Limb training device 200 includes a first portion 202 and a second portion 230 rotationally couplable to each other to rotate around a common rotational axis 272. In the embodiment 200, no limb engagement finger retaining lips are provided, in order to make installation and removal on a plant limb L easier for limbs that are less likely to warp or slide out of engagement.

First portion 202 extends lengthwise from a first fulcrum portion 204 to a first limb engagement finger 206. In the embodiment, first fulcrum portion 204 is substantially cylindrical, extending from outer end 226 to terminal end 228. First fulcrum portion 204 includes circular interior race 208 extending between outer end 226 and terminal end 228. First fulcrum portion 204 includes a base flange 278 extending outward around first fulcrum portion outer end 226. Base flange 278 acts as a retainer and bearing surface against second fulcrum portion terminal end 256. First portion arm 210 extends lengthwise from a first end 260 rigidly connected to first fulcrum portion 204 proximate outer end 226 to a second end 262. First limb engagement finger 206 extends from first portion arm 210 proximate first portion arm second end 262 to a first limb engagement finger terminal end 212. In the embodiment, first limb engagement finger 206 defines a flat wall having a transverse width 264. First limb engagement finger inner surface 216 goes against a selected limb L.

First fulcrum portion retaining groove 218 extends circumferentially around interior race 208 proximate the outer end 226 of first fulcrum portion 204. Ratchet teeth 220 are disposed around interior race 208, extending proximate to first fulcrum portion terminal end 228. In the embodiment, ratchet teeth 220 are angled to permit first and second portions 202, 230 to rotate relative to each other in only one direction.

Second portion 230 includes second fulcrum portion 232 which defines a round cylindrical bushing to rotationally engage first fulcrum portion 202 interior race 208. Second fulcrum portion 232 extends from an outer end 254 to a terminal end 256. Second fulcrum portion 232 includes first and second opposed parallel longitudinal slots 236, 238, extending from proximate outer end 254 to terminal end 256, effectively creating a split-cylinder with opposed first and second halves 232a and 232b, respectively. Longitudinal slots 236, 238, permit second fulcrum portion 232 to compress for easier insertion/assembly. Pawl 252 is disposed proximate first longitudinal slot 236 proximate second fulcrum portion outer end 254 to engage ratchet teeth 220.

Second fulcrum portion 232 includes first and second projecting ridges 248a, 248b, to engage within first fulcrum portion retaining groove 218, preventing separation of first portion 202 from second portion 230 while permitting rotation about the rotation axis 272.

Second portion arm 240 extends lengthwise from a first end 266 rigidly connected to second fulcrum portion 232 proximate outer end 226 to a second portion arm second end 268. Second limb engagement finger 234 is rigidly connected to and extends orthogonally from second portion arm 240 proximate its second end 268 to second limb engagement finger terminal end 242. In the embodiment, second limb engagement finger 134 defines a flat wall having transverse width 170. Second limb engagement finger inner surface 146 goes against a limb L.

Referring to FIG. 9, with training device 200 in the “neutral” position, first portion arm 210 is curved to provide first limb engagement finger inner surface 216 upstream offset 222 and radial offset 224 from rotational axis 272. Second portion arm 240 is curved to provide second limb engagement finger inner surface 146 downstream lateral offset 250 and radial offset 224.

When first and second portions 202, 230, are coupled, first portion arm 210 and second portion arm 240 extend from opposite sides of the central fulcrum formed by first fulcrum portion 204 and second fulcrum portion 232, and face toward each other such that first and second limb engagement fingers 206, 234, respectively, rotate in approximately the same cylinder/disk plane. Second portion arm 240 is longer than first portion arm 210 so that the arms 210, 240, can rotate through 360-degrees in order to reset. First and second portion arms 210, 240, respectively, are curved toward each other in opposed arcs which allows the first and second portion arms 210, 240, respectively, to engage a straight branch. First fulcrum portion 204 and second fulcrum portion 232 are open through their respective centers, defining a central aperture 274. In the embodiment, pawl access aperture 276 provides access to pawl 252 with prying device if necessary to disengage apparatus 200 from a limb L under high bending stress.

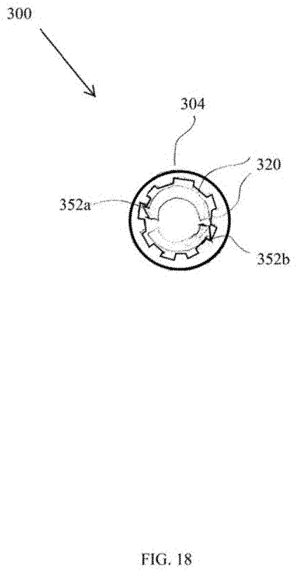

Referring to FIG. 18, a third embodiment 300 of a limb training device is shown. In the third embodiment 300, first fulcrum portion 304 includes squared ratchet teeth 320 to engage against pawls 352a and 352b. Squared ratchet teeth profiles tend to provide less holding strength than angled-skewed teeth for a given size and material, but are easier to produce with injection molding methods, so may be suitable for use with more pliable limbs L.

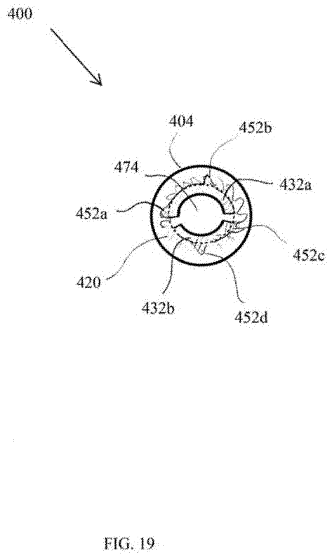

Referring to FIG. 19, a fourth embodiment 400 of a limb training device is shown. In the embodiment, second fulcrum portion 432a and 432b includes a plurality of pawls 452a, 452b, 452c, 452d disposed around 432a and 432b to engage ratchet teeth 420. Central aperture 474 is shown for orientation.

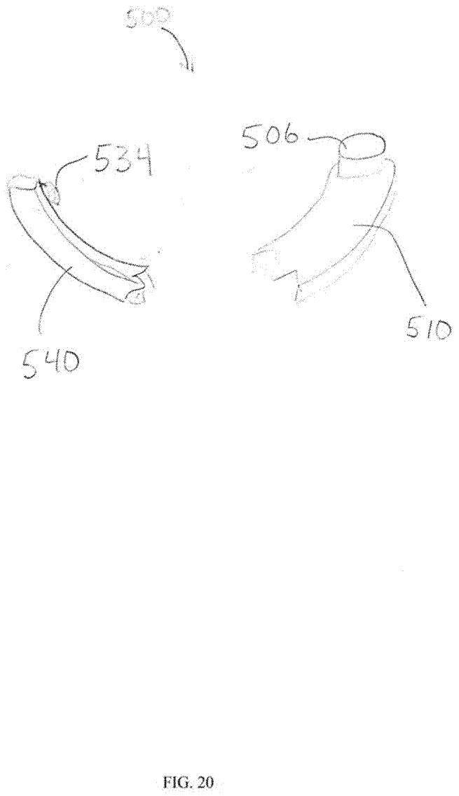

Referring to FIG. 20, a fifth embodiment 500 of a limb training device is shown. In the embodiment, first limb engagement finger 506 projecting from first portion arm 510 and second limb engagement finger 534 projecting from second portion arm 540 are round posts, which may be useful in situations not requiring sensitivity to scarring the epidermis of the plant limb.

Larger embodiments may require stronger materials, such as high-strength plastics, metal or similar materials. Second fulcrum portion first and second longitudinal slots (e.g. 136, 138; 236, 238), may be dimensioned and/or strengthened to receive a flathead screwdriver or similar tool to assist the user in setting the desired bend angle. Second fulcrum portion terminal end (e.g. 156, 256) may be configured to receive a wrench, such as an Allen wrench or similar torque device, which may be especially useful for scaled-up applications sized for tree limbs.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

We claim:

1. An apparatus for training plant limbs, comprising:
a first portion, the first portion including a first fulcrum portion, a first portion arm extending from a first portion arm first end connected to the first fulcrum portion to a first portion arm second end, a first limb engagement finger projecting from the first portion arm proximate the first portion arm second end, the first fulcrum portion further including an interior race and a plurality longitudinally oriented ratchet teeth disposed circunferentially around the interior race; and,
a second portion, the second portion including a second fulcrum portion, a second portion arm extending from a second portion arm first end connected to the second fulcrum portion to a second portion arm second end, a second limb engagement finger projecting from the second portion arm proximate the second portion arm second end, the second fulcrum portion configured to engage the first fulcrum portion within the first fulcrum portion interior race, the second fulcrum portion further including at least one pawl element disposed to selectively engage the plurality of ratchet teeth.

2. The apparatus of claim 1, further comprising:
wherein when the first portion first fulcrum portion rotationally engages the second portion second fulcrum portion the first and second limb engagement fingers are in opposed orientation.

3. The apparatus of claim 1, further comprising:
the first fulcrum portion and second fulcrum portion defining a central rotation axis about which the first portion arm and second portion arm rotate in opposed directions;

4. The apparatus of claim 3, further comprising:
the apparatus including a neutral position wherein the first portion arm and second portion arm impart no bending stress on a straight limb engaged by the apparatus, the neutral position further defining a first limb engagement finger upstream offset and radial offset and a second limb engagement finger downstream offset and radial offset, wherein the first limb engagement finger radial offset and second limb engagement finger radial offset are equal magnitude and direction.

5. The apparatus of claim 1, further comprising:
wherein the plurality of ratchet teeth is unidirectional.

6. The apparatus of claim 1, further comprising:
wherein the plurality of ratchet teeth is square.

7. The apparatus of claim 1, further comprising:
a plurality of pawls disposed around the second fulcrum portion.

8. The apparatus of claim 1, further comprising:
wherein the second portion arm is longer than the first portion arm.

9. The apparatus of claim 1, further comprising:
a third limb engagement finger projecting from the second portion arm between the second portion arm first and second ends and distal from the second limb engagement finger.

10. The apparatus of claim 1, further comprising:
wherein the respective first and second limb engagement fingers each further include a respective projecting retaining lip.

11. The apparatus of claim 1, further comprising:
wherein the respective first and second limb engagement fingers each further include a flat interior surface to go against a limb.
